(19) United States
(12) Patent Application Publication
(10) Pub. No.: US 2025/0348055 A1
(43) Pub. Date: Nov. 13, 2025

(54) METHOD OF PREDICTING FAILURE PATTERN

(71) Applicant: SAMSUNG ELECTRONICS CO., LTD., Suwon-si (KR)

(72) Inventors: Yeongchan CHO, Suwon-si (KR); Seongjeon CHOI, Suwon-si (KR); Hungbae AHN, Suwon-si (KR); Wonchan LEE, Suwon-si (KR)

(73) Assignee: SAMSUNG ELECTRONICS CO., LTD., Suwon-si (KR)

(21) Appl. No.: 19/202,349

(22) Filed: May 8, 2025

(30) Foreign Application Priority Data
May 8, 2024 (KR) 10-2024-0060761

(51) Int. Cl. G05B 19/4099

(52) U.S. Cl. CPC G05B 19/4099; G05B 2219/45031

(57) ABSTRACT

A failure pattern prediction method includes obtaining first optical parameters of first patterns, extracting first data by performing a first dimensional reduction method on the first optical parameters and generating a failure pattern prediction model by performing supervised learning on the first patterns based on the first data.

### CROSS-REFERENCE TO RELATED APPLICATIONS

This application is based on and claims priority to Korean Patent Application No. 10-2024-0060761, filed on May 8, 2024, in the Korean Intellectual Property Office, the disclosure of which is incorporated by reference herein in its entirety.

### BACKGROUND

Example embodiments of the disclosure relate to a method of predicting a patterning result.

In a semiconductor process, a photolithography process using a mask may be performed to form a pattern on a semiconductor substrate, such as a wafer. A mask may be defined as a pattern transfer material including an opaque material of a pattern shape formed on a transparent base material. In a mask manufacturing process, for example, a required circuit may be designed, a layout of the circuit may be designed, and then design data obtained through optical proximity correction (OPC) may be delivered as mask tape-out (MTO) design data. Thereafter, mask data preparation (MDP) may be performed based on the MTO design data, and an exposure process, etc., may be performed on a mask substrate.

In the process of forming a pattern on a substrate, it is important to predict whether the pattern is normally formed on a substrate through mask data, etc., and as technology advances, the complexity of the process increases and the difficulty of prediction increases.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide a failure pattern prediction method capable of achieving high accuracy.

Additional aspects will be set forth in part in the description which follows and, in part, will be apparent from the description, or may be learned by practice of the presented embodiments.

According to an aspect of an example embodiment, a failure pattern prediction method may include obtaining first optical parameters of first patterns, extracting first data by performing a first dimensional reduction method on the first optical parameters and generating a failure pattern prediction model by performing supervised learning on the first patterns based on the first data.

According to an aspect of an example embodiment, a failure pattern prediction method may include obtaining, by an optical parameter obtaining module, first optical parameters of first patterns and second optical parameters of second patterns, extracting, by a dimensional reduction module, first data by performing a first dimensional reduction method on the first optical parameters, generating, by a model generation module, a failure pattern prediction model by performing supervised learning based on first exposure data of the first patterns and the first data, extracting, by the dimensional reduction module, second data by performing a second dimensional reduction method on the second optical parameters, and verifying, by a model verification module, the failure pattern prediction model by comparing prediction data with second exposure data of the second patterns, where the prediction data is obtained by applying the failure pattern prediction model to the second data.

According to an aspect of an example embodiment, a failure pattern prediction method may include obtaining first optical parameters of first patterns, extracting three-dimensional first data by performing a first dimensional reduction method on the first optical parameters, generating a failure pattern prediction model by performing supervised learning based on the three-dimensional first data and first exposure data including failure information of each of the first patterns, and verifying the failure pattern prediction model based on second patterns, where the generating of the failure pattern prediction model includes determining a hyper plane for classifying the first patterns in a virtual three-dimensional space based on whether the first patterns are a failure.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a flowchart illustrating a failure pattern prediction method according to one or more embodiments;

FIG. 2 is a diagram illustrating a process of a failure pattern prediction method according to one or more embodiments;

FIGS. 3A and 3B are images of examples of a failure pattern according to one or more embodiments;

FIG. 4 is a diagram illustrating examples of first patterns and second patterns that may be used in a failure pattern prediction method;

FIG. 5 is a table illustrating a test of prediction performance of first optical parameters obtained from first patterns used in a failure pattern prediction method according to one or more embodiments;

FIG. 6A is a table illustrating a test of prediction performance of first data extracted by performing a dimensional reduction method performed on first optical parameters used in a failure pattern prediction method according to one or more embodiments;

FIG. 6B is a graph illustrating a degree to which first data used in a failure pattern prediction method represents information about first optical parameters according to one or more embodiments;

FIG. 7 is a diagram illustrating points respectively corresponding to first patterns, along with whether patterning failed or not, in a dimension of first data, according to one or more embodiments;

FIGS. 8A and 8B are diagrams illustrating a hyper plane determined through supervised learning in the failure pattern prediction method according to one or more embodiments;

FIG. 9 is a flowchart illustrating a method of verifying a failure pattern prediction model, according to one or more embodiments;

FIG. 10 is a flowchart illustrating a method of verifying a failure pattern prediction model, according to one or more embodiments;

FIG. 11 is a diagram illustrating a prediction system that performs a failure pattern prediction method according to one or more embodiments; and

FIG. 12 is a block diagram of a prediction system according to one or more embodiments

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

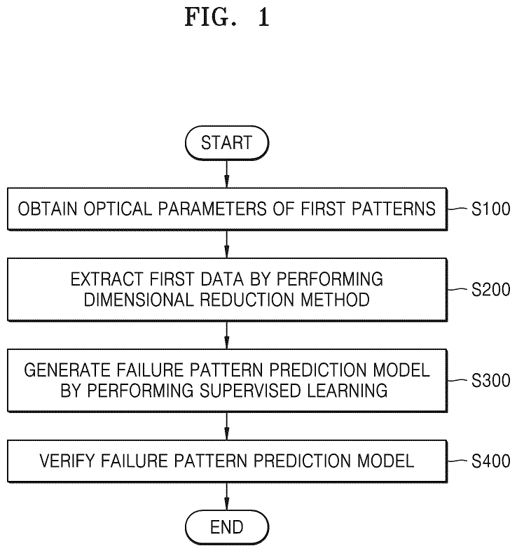

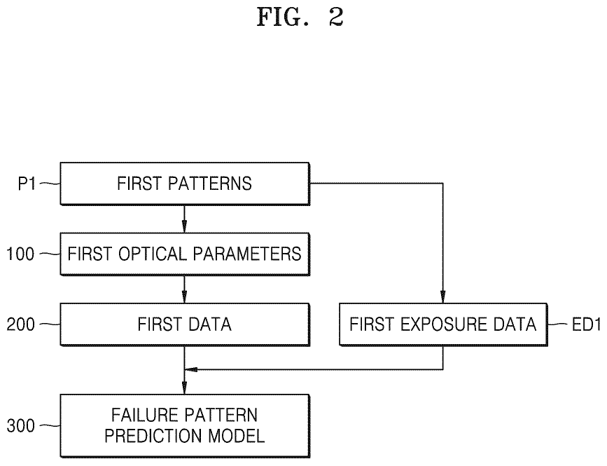

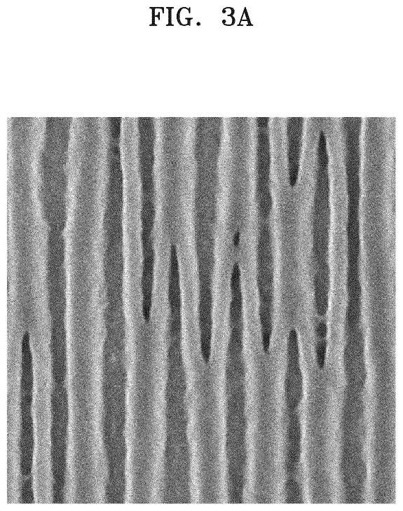

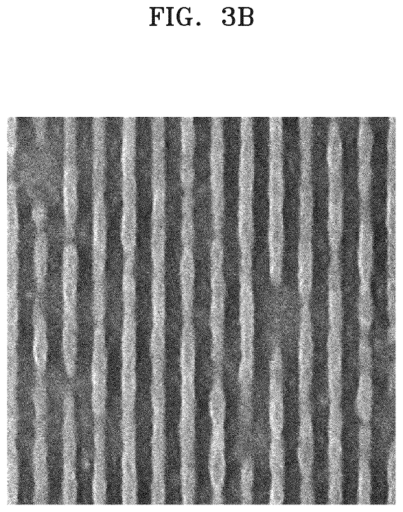

FIG. 1 is a flowchart illustrating a failure pattern prediction method according to one or more embodiments. FIG. 2 is a diagram illustrating a process of a failure pattern prediction method according to one or more embodiments. FIGS. 3A and 3B are images of examples of a failure pattern. FIGS. 3A and 3B represent actual images.

Referring to FIGS. 1 and 2 together, the failure pattern prediction method according to one or more embodiments may include operation S100 of obtaining first optical parameters 100 of first patterns P1, operation S200 of extracting first data 200 by performing a dimensional reduction method on the first optical parameters 100, operation S300 of generating a failure pattern prediction model 300 by performing supervised learning on the first patterns P1 based on the first data 200, and operation S400 of verifying the failure pattern prediction model 300.

A failure pattern may refer to a pattern in which patterning is not performed as intended and may include hard failures such as bridging where adjacent patterns are attached to each other or necking where patterns are broken. The failure pattern may refer to an after development inspection (ADI) pattern in which a defect occurred.

FIG. 3A is an image showing a bridging-type failure in which adjacent patterns are attached to each other, although a pattern including repetitive vertical bar patterns and spaces therebetween was intended. FIG. 3B is an image showing a necking-type failure in which vertical patterns are broken, although a pattern including repetitive vertical bar patterns and spaces therebetween was intended. Failure pattern prediction refers to predicting whether such failure patterns are to occur. By accurately predicting a patterning failure in advance, the product development period may be shortened and mass production yield may be improved.

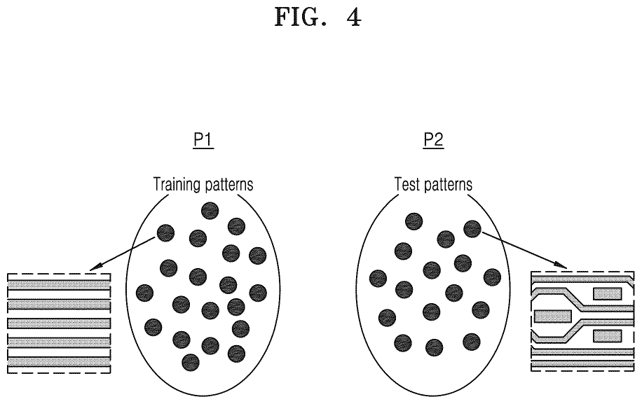

FIG. 4 is a diagram illustrating examples of first patterns P1 and second patterns P2 that may be used in a failure pattern prediction method.

The first patterns P1 and the second patterns P2 may be different data sets. The first patterns P1 may be used to generate the failure pattern prediction model 300 (see FIG. 2) before design of a product layer is determined. The first patterns P1 may be a relatively small number of training patterns for learning the failure pattern prediction model 300 (see FIG. 2). The second patterns P2 may be patterns for a product layer, and may be test patterns used when verifying the failure pattern prediction model 300 (see FIG. 2) generated using the first patterns P1.

Referring back to FIGS. 1 and 2, the failure pattern prediction method according to one or more embodiments may include operation S100 of obtaining the first optical parameters 100 of the first patterns P1. The first optical parameters 100 may include a plurality of types of optical parameters including optical information. For example, the first optical parameters 100 may include at least one of Normalized Image Log-Slope (NILS), Image Log-Slope (ILS), maximum Intensity (Imax), minimum Intensity (Imin), optic critical dimension (CD), simulated CD, mask CD, an optical threshold, a normalized aerial image slope, and a ratio of optic and resist intensity. The first optical parameters 100 may be obtained using data extracted in a process development stage. For example, as the first optical parameters 100 of the first patterns P1, optical parameters of the first patterns P1 extracted through an optical proximity correction (OPC) modeling process may be used.

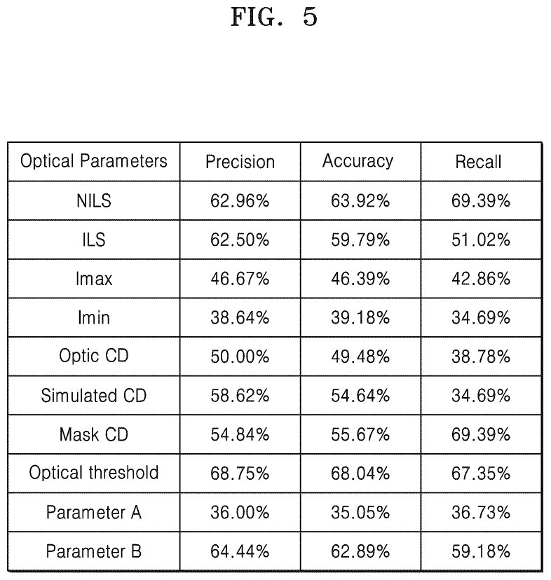

FIG. 5 is a table illustrating a test of prediction performance of first optical parameters 100 obtained from first patterns P1 used in a failure pattern prediction method according to one or more embodiments. The prediction performance of each of the first optical parameters 100 shown in FIG. 5 may refer to the performance of predicting a pattern failure through a model of each of the first optical parameters 100. In the test shown in FIG. 5, the first optical parameters 100 are NILS, ILS, Imax, Imin, optic CD, simulated CD, mask CD, an optical threshold, a normalized aerial image slope, and a ratio of optic and resist intensity.

Referring to FIG. 5, a performance indicator of each of the first optical parameters 100 was evaluated as 70% or less in all items (precision, accuracy, and recall). In the case of NILS, which is commonly used to predict failure patterns, precision, accuracy, and recall were evaluated at 62.96%, 63.92%, and 69.39%, respectively. For reference, performance indicators of precision, accuracy, and recall may be defined as Equations (1) to (3), respectively.

$$Precision = \frac{T P}{T P + F P} \qquad ( 1 )$$

$$Accuracy = \frac{T P + T N}{T P + T N + F P + F N} \qquad ( 2 )$$

$$Recall = \frac{T P}{T P + F N} \qquad ( 3 )$$

Referring to Equations (1) to (3) together with Table 1, precision may refer to the ratio of actual failures (TP) among patterns predicted to be failures (TP+FP), recall may refer to the ratio of failures (TP) that are predicted by the model as a failure, among the actual patterns (TP+FN), and accuracy may refer to the ratio of the actual failures and actual successes that are correctly predicted.

TABLE 1

Actual

| | | Positive | Negative |
|---|---|---|---|
| | | (pattern failure) | (pattern success) |
| Predicted | Positive | True Positive | False positive |
| | (pattern | (TP) | (FP) |
| | failure) | | |
| | Negative | False Negative | True Negative |
| | (pattern | (FN) | (TN) |
| | success) | | |

Referring again to FIGS. 1 and 2, the failure pattern prediction method according to one or more embodiments may include operation S200 of extracting the first data 200 by performing a dimensional reduction method on the first optical parameters 100.

In one or more embodiments, the dimensional reduction method may include at least one of principal component analysis (PCA), kernel PCA (KPCA), linear discriminant analysis (LDA), multidimensional scaling (MDS), singular value decomposition (SVD), locally linear embedding (LLE), isometric mapping (ISOMAP), Laplacian Eigenmaps (LE), independent component analysis (ICA), and t-distributed stochastic neighbor embedding (t-SNE). The first data 200 may be data with a dimension reduced from a dimension of the first optical parameters 100. For example, when PCA is performed, the first data 200 may include at least one principal component (PC).

The first data 200 may enable prediction of a failure pattern with higher accuracy than the first optical parameters 100.

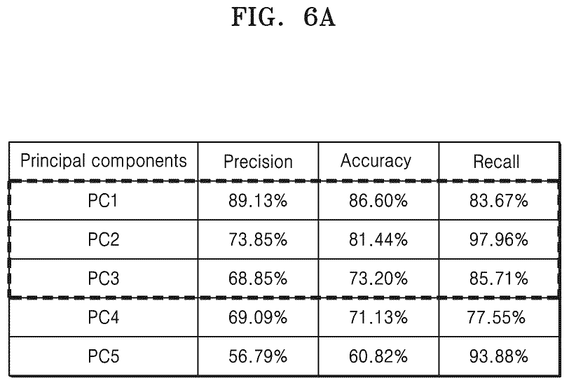

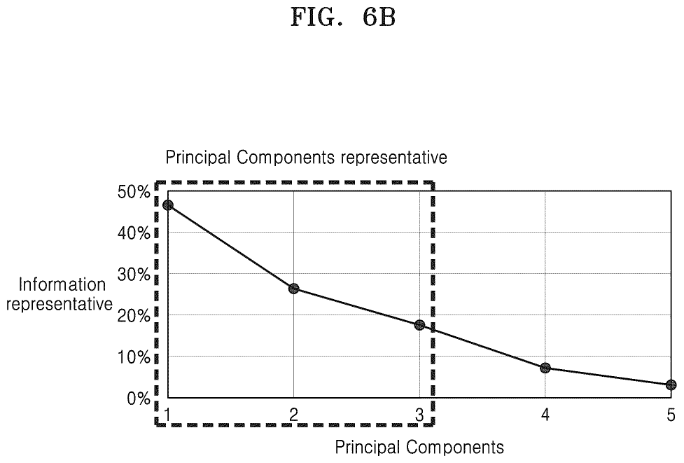

FIG. 6A is a table illustrating a test of prediction performance of first data 200 extracted by performing a dimensional reduction method performed on first optical parameters used in a failure pattern prediction method according to one or more embodiments. FIG. 6B is a graph illustrating a degree to which first data 200 used in a failure pattern prediction method represents information about first optical parameters 100 according to one or more embodiments. FIGS. 6A and 6B illustrate a case in which PCA is performed as a dimensional reduction method, and as described above, in this case, the first data 200 may include at least one extracted PC.

FIG. 6A shows results of dimensional reduction performed on the 10-dimensional first optical parameters 100 of FIG. 5, and shows indicators for the pattern failure prediction performance of each of the five PCs (PC1, PC2, PC3, PC4, and PC5). Referring to FIG. 6A, it may be seen that the performance indicators for the top three PCs (PC1, PC2, and PC3) range from about 73% to about 98%. This is significantly improved compared to the prediction performance indicators of the first optical parameters 100 described above with reference to FIG. 5. Also, referring to FIG. 6B, PC1, PC2, and PC3 may represent about 90% of the information of the existing 10-dimensional data before dimensional reduction.

In the failure pattern prediction method according to one or more embodiments, by performing a dimensional reduction method on the first optical parameters 100 of the first patterns P1, the first data 200 having a smaller dimension than the first optical parameters 100 but having higher prediction performance may be extracted. The first data 200 may be selected (or extracted) as data of an appropriate dimension that may represent information about the first optical parameters 100. In one or more embodiments, the first data 200 may be three-dimensional data or data of a lesser dimension, and in this case, the first data 200 may be visually expressed in virtual space.

Referring back to FIGS. 1 and 2, the failure pattern prediction method according to one or more embodiments may include operation S300 of generating the failure pattern prediction model 300 by performing supervised learning on the first patterns P1 based on the first data 200.

In one or more embodiments, supervised learning may include at least one of techniques among Support Vector Machine (SVM), K-Nearest Neighbors (KNN), random forest, gradient boosting, naïve Bayes, and logistic regression.

Supervised learning on the first patterns P1 may be performed using the first exposure data ED 1 together with the first data 200. The first exposure data ED1 may include failure information about each of the first patterns P1. That is, the first exposure data ED1 may indicate whether each of the first patterns P1 actually exposed to a substrate has failed. In one or more embodiments, the first exposure data ED 1 may be wafer data obtained by exposing each of the first patterns P1 to a substrate. In one or more embodiments, the first exposure data ED 1 may include data about failure patterns sorted by an engineer by exposing each of the first patterns P1 to a substrate and then measuring CDs of the first patterns P1. This sorting process may be a task that consumes a significant amount of time and personnel resources (e.g., engineers). According to one or more embodiments, data extracted from a process development stage may be used as the first exposure data ED1. For example, data extracted (e.g., sorted by an engineer) in an OPC modeling process may be used as is, as the first exposure data ED1.

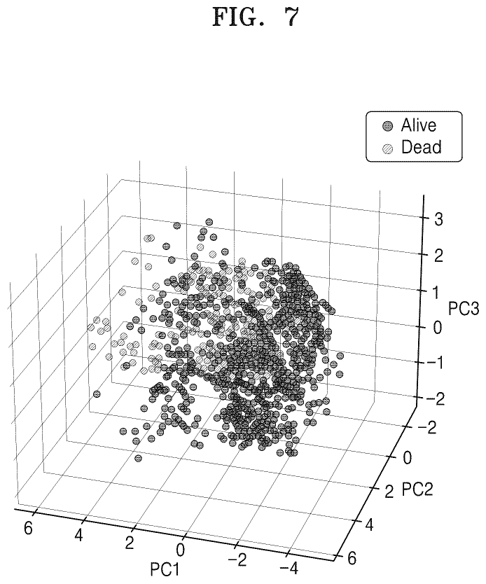

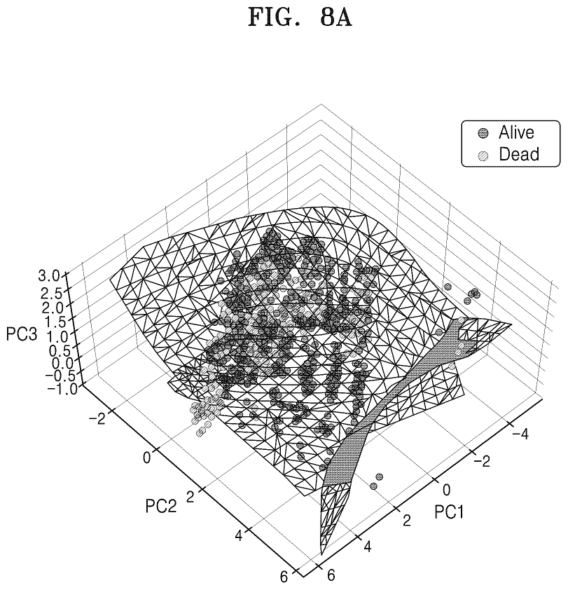

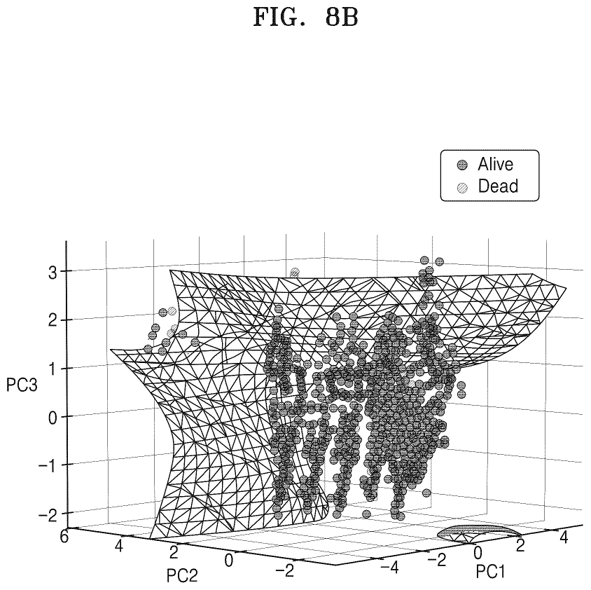

FIG. 7 is a diagram illustrating points respectively corresponding to first patterns P1, along with whether patterning failed or not, in a dimension of first data 200, according to one or more embodiments. FIGS. 8A and 8B are diagrams illustrating a hyper plane (HP) determined through supervised learning in the failure pattern prediction method according to one or more embodiments. FIGS. 7, 8A, and 8B show examples of using an SVM technique, which has a low risk of over-fitting and is suitable for determining nonlinear boundaries among various supervised learning techniques. However, embodiments are not limited thereto, and other techniques may be implemented

The first data 200 of FIG. 7 corresponds to PC1, PC2, and PC3 described with reference to FIGS. 6A and 6B, and FIGS. 8A and 8B show an HP of a maximum margin for classification of a success pattern (alive) and a failure pattern (dead) shown in FIG. 7.

In one or more embodiments, operation S300 of generating the failure pattern prediction model 300 may be represented by first stamping points respectively corresponding to the first patterns P1 in a dimensional space of the first data 200. By using the first exposure data ED1 described above, points respectively corresponding to the first patterns P1 may include whether or not patterning has failed. FIG. 7 shows points respectively corresponding to the first patterns P1 in a dimensional space of PC1, PC2, and PC3 (i.e., three-dimensional space) along with whether patterning has failed (alive or dead). Referring to FIG. 7, success patterns (alive) and failure patterns (dead) may be separately clustered in a three-dimensional space.

In one or more embodiments, in operation S300 of generating the failure pattern prediction model 300, a boundary for classifying the first patterns P1 as a failure or not, through supervised learning in the dimension of the first data 200, may be determined. In one or more embodiments, the boundary that classifies the first patterns P1 as a failure or not a failure may be an HP of a maximum margin.

FIGS. 8A and 8B show an HP determined as a boundary for classifying the first patterns P1 as a failure or not (success pattern (alive) and failure pattern (dead)). Referring to FIGS. 8A and 8B showing graphs from different directions, it may be seen that the first patterns P1 are classified into success patterns (alive) and failure patterns (dead) by the HP.

In the failure pattern prediction method according to one or more embodiments, the first patterns P1, which may be training patterns for generating the failure pattern prediction model 300, may be prepared, and as an example of a plurality of types of optical parameters of the first patterns P1, first optical parameters 100 of ten dimensions may be obtained. Thereafter, PCA may be performed on the first optical parameters 100 of ten dimensions as an example of a dimensional reduction method to extract three-dimensional first data 200. Then, in a three-dimensional space of the first data 200, an SVM technique may be performed, as an example of supervised learning, using the first exposure data ED1 including information indicating whether or not patterning of the first patterns P1 failed, and the failure pattern prediction model 300 may be generated. In the supervised learning, an HP whereby the first patterns P1 are classified into success patterns (alive) or failure patterns (dead) may be determined.

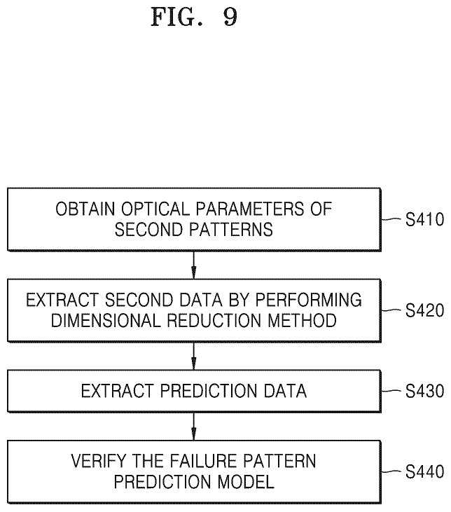

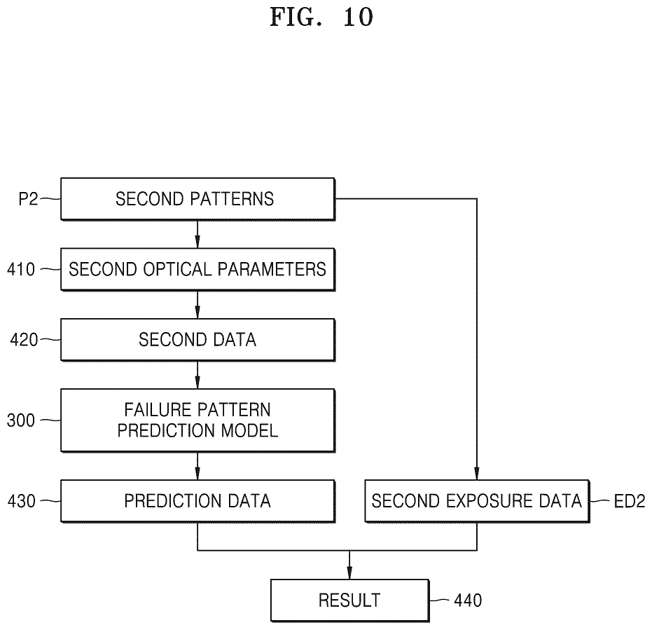

FIG. 9 is a flowchart illustrating a method of verifying a failure pattern prediction model, according to one or more embodiments. FIG. 10 is a flowchart illustrating a method of verifying a failure pattern prediction model, according to one or more embodiments. FIG. 9 is a diagram showing operation S400 of verifying the failure pattern prediction model of FIG. 1.

Referring to FIG. 9, operation S400 of verifying the failure pattern prediction model may include operation S410 of obtaining second optical parameters 410 of the second patterns P2, operation S420 of extracting second data 420 by performing a dimensional reduction method on the second optical parameters 410, operation S430 of extracting prediction data 430 by applying the failure pattern prediction model 300 to the second data 420, and operation S440 of verifying the failure pattern prediction model by comparing the prediction data 430 with the second exposure data ED2.

In one or more embodiments, the second patterns (P2, see FIG. 4) may be a different data set from the first patterns (P1, see FIG. 4). The second patterns (P2, see FIG. 4) may be test patterns for verification. The second optical parameters 410 of the second patterns P2 may be a plurality of types of optical parameters including optical information. For example, the second optical parameters 410 may include at least one of NILS, ILS, Imax, Imin, optic CD, simulated CD, mask CD, an optical threshold, a normalized aerial image slope, and a ratio of optic and resist intensity, respectively. The second optical parameters 410 may be obtained using data extracted in a process development stage. For example, optical parameters of the second patterns P2 extracted from the OPC modeling process may be used as the second optical parameters 410 of the second patterns P2.

The second data 420 may be extracted by performing a dimensional reduction method on the second optical parameters 410 in operation S420. The dimensional reduction method may include at least one of PCA, KPCA, LDA, MDS, SVD, LLE, ISOMAP, LE, ICA, and t-SNE. The second data 420 may be data with a dimension reduced from a dimension of the second optical parameters 410. For example, when PCA is performed, the second data 420 may include at least one PC.

The prediction data 430 may be extracted by applying the failure pattern prediction model 300 to the second data 420 in operation S430. The prediction data 430 may be data indicating a prediction on whether each of the second patterns P2 has failed. The prediction data 430 may be data in which a patterning failure of each of the second patterns P2 is predicted through an HP determined for the first patterns P1.

Operation S400 may include operation S440 of verifying the failure pattern prediction model 300 by comparing the prediction data 430 with the second exposure data ED2. The second exposure data ED2 may include failure information about each of the second patterns P2. That is, the second exposure data ED2 may include data on whether each of the second patterns P2 actually exposed to a substrate has failed. In one or more embodiments, the second exposure data ED2 may be wafer data obtained by exposing each of the second patterns P2 to a substrate. In one or more embodiments, the second exposure data ED2 may include data about failure patterns sorted by an engineer by exposing each of the second patterns P2 to a substrate and then measuring CDs of the second patterns P2. This sorting process may be a task that consumes a significant amount of time and personnel resources (e.g., engineers). According to one or more embodiments, data extracted from a process development stage may be used as the second exposure data ED2. For example, data extracted (sorted by an engineer) in an OPC modeling process may be used as the second exposure data ED2.

According to one or more embodiments, a result value 440 obtained by verifying the failure pattern prediction model 300 may be extracted using the prediction data 430 and the second exposure data ED2. If the result value 440 satisfies a reference value, the failure pattern prediction model 300 may be completed. If the result value 440 does not satisfy the reference value, the failure pattern prediction model 300 may be modified. For example, if the result value 440 does not satisfy the reference value, the dimensional reduction method and/or supervised learning technique used to generate the failure pattern prediction model 300 may be changed.

Table 2 is a table showing the prediction performance of the failure pattern prediction model 300 verified by comparing the prediction data 430 with the second exposure data ED2. As a result of comparing the prediction performance of Embodiment 1 with NILS (i.e., related art methodology), it was confirmed that Embodiment 1 showed significantly higher performance indicators in all items (accuracy, precision, and recall). Embodiment 1 may have excellent prediction performance with accuracy, precision, and recall items of 95.71%, 95.68%, and 99.63%, respectively.

TABLE 2

| item | NILS | Embodiment 1 |
|---|---|---|
| Accuracy | 63.92% | 95.71% |
| Precision | 62.96% | 95.68% |
| Recall | 69.39% | 99.63% |

Additionally, as described above with reference to FIGS. 1 to 10, in the failure pattern prediction method according to one or more embodiments, optical parameters of patterns are used, thus making calibration easy.

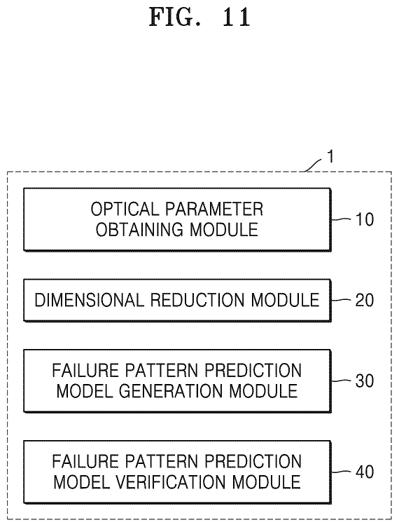

FIG. 11 is a diagram illustrating a prediction system 1 that performs a failure pattern prediction method according to one or more embodiments. The prediction system 1 may include an optical parameter obtaining module 10, a dimensional reduction module 20, a model generation module 30, and a model verification module 40. As used herein, a module may refer to a functional and structural combination of hardware for carrying out the embodiments and software for driving the hardware. For example, a module may refer to a logical unit of hardware resources for executing a certain code and the code, and may not necessarily refer to a physically connected code or one type of hardware.

The optical parameter obtaining module 10 may obtain the first optical parameters (100, see FIG. 2) of the first patterns (P1, see FIG. 2) and/or the second optical parameters (410, see FIG. 10) of the second patterns (P2, see FIG. 10). The optical parameter obtaining module 10 may receive the first optical parameters (100, see FIG. 2) and/or the second optical parameters (410, see FIG. 10) from a separate system.

The dimensional reduction module 20 may extract the first data (200, see FIG. 2) by performing a dimensional reduction method on the first optical parameters (100, see FIG. 2). The dimensional reduction module 20 may extract the second data (420, see FIG. 10) by performing a dimensional reduction method on the second optical parameters (410, see FIG. 10).

The model generation module 30 may generate the failure pattern prediction model (300, see FIG. 2) by performing supervised learning based on the first exposure data (ED1, see FIG. 2) of the first patterns (P1, see FIG. 2) and the first data (200, see FIG. 2). The model generation module 30 may receive the first exposure data ED1.

The model verification module 40 may perform verification of the failure pattern prediction model 300 (see FIGS. 2 and 10). The model verification module 40 may verify the failure pattern prediction model (300, see FIGS. 2 and 10) by using the prediction data (430, FIG. 10) obtained by inputting the second data (420, see FIG. 10) into the failure pattern prediction model (300, see FIGS. 2 and 10) and the second exposure data (ED2, see FIG. 10) of the second patterns (P2, see FIG. 10). The model verification module 40 may receive the second exposure data ED2.

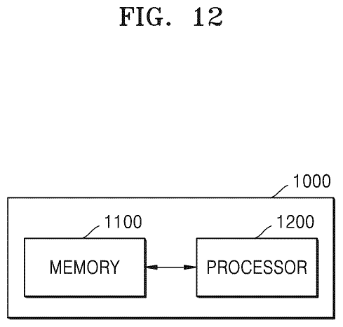

FIG. 12 is a block diagram of a prediction system according to one or more embodiments.

As shown in FIG. 12, the prediction system 1000 may include a memory 1100 and a processor 1200. However, the configuration shown in FIG. 12 is an example for implementing the embodiments, and other hardware and software configurations may be additionally included in the prediction system 1000 as will be understood to one of ordinary skill in the art from the disclosure herein. According to one or more embodiments, the prediction system 1000 may be implemented in the form of an electronic device.

The prediction system 1000 according to one or more embodiments may be configured to perform operations such as obtaining first optical parameters of first patterns, extracting first data by performing dimensional reduction on the first optical parameters, and generating a failure pattern prediction model by performing supervised learning on the first patterns based on the first data.

The memory 1100 may store commands or data related to at least one other component of the prediction system 1000. Also, the memory 1100 may be accessed by the processor 1200, and reading/writing/modifying/deleting/updating of data may be performed by the processor 1200.

The term memory may include the memory 1100, a read-only memory (ROM) or a random access memory (RAM) in the processor 1200, or a memory card (e.g., a micro secure digital (SD) card or a memory stick) mounted in the prediction system 1000. In addition, the memory 1100 may store programs and data for configuring various screens to be displayed on a display area of a display.

According to one or more embodiments, the memory 1100 may include a non-volatile memory capable of maintaining stored information even if power supply is interrupted, and a volatile memory requiring continuous power supply to maintain stored information. For example, the non-volatile memory may be implemented as at least one of one time programmable ROM (OTPROM), programmable ROM (PROM), erasable and programmable ROM (EPROM), electrically erasable and programmable ROM (EEPROM), mask ROM, or flash ROM, and the volatile memory may be implemented as at least one of dynamic RAM (DRAM), static RAM (SRAM), or synchronous dynamic RAM (SDRAM).

The processor 1200 may be electrically connected to the memory 1100 to control all operations and functions of the prediction system 1000.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to one or more embodiments, the module may be implemented in a form of an application-specific integrated circuit (A SIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one or more embodiments, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the components, elements, modules, units, or the like (collectively “components” in this paragraph) represented by a block or an equivalent indication (collectively “block”) in the above embodiments including the drawings, for example, slicer, flip-flop, etc., may be physically implemented by analog or digital circuits such as logic gates, integrated circuits, microprocessors, microcontrollers, memory circuits, passive electronic components, active electronic components, optical components, hardwired circuits, or the like, and may be driven by firmware and software. The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A failure pattern prediction method comprising:
obtaining first optical parameters of first patterns;
extracting first data by performing a first dimensional reduction method on the first optical parameters; and
generating a failure pattern prediction model by performing supervised learning on the first patterns based on the first data.

2. The failure pattern prediction method of claim 1, wherein the supervised learning on the first patterns is performed based on first exposure data comprising failure information about each of the first patterns.

3. The failure pattern prediction method of claim 1, wherein the generating of the failure pattern prediction model comprises determining a boundary for classifying the first patterns as a failure through supervised learning in a dimension of the first data.

4. The failure pattern prediction method of claim 3, wherein the boundary for classifying the first patterns as a failure comprises a hyper plane of a maximum margin for classifying the first patterns.

5. The failure pattern prediction method of claim 1, wherein the supervised learning comprises at least one of Support Vector Machine (SVM), K-Nearest Neighbors (KNN), random forest, gradient boosting, naïve Bayes, and logistic regression.

6. The failure pattern prediction method of claim 1, wherein the first dimensional reduction method comprises at least one of principal component analysis (PCA), kernel PCA (KPCA), linear discriminant analysis (LDA), multidimensional scaling (MDS), singular value decomposition (SVD), locally linear embedding (LLE), isometric mapping (ISOMAP), Laplacian Eigenmaps (LE), independent component analysis (ICA), and t-distributed stochastic neighbor embedding (t-SNE).

7. The failure pattern prediction method of claim 1, further comprising obtaining second optical parameters of second patterns.

8. The failure pattern prediction method of claim 7, further comprising extracting second data by performing a second dimensional reduction method on the second optical parameters.

9. The failure pattern prediction method of claim 8, further comprising extracting prediction data indicating whether each of the second patterns has failed by applying the failure pattern prediction model to the second data.

10. The failure pattern prediction method of claim 9, further comprising verifying the failure pattern prediction model by comparing the prediction data with second exposure data comprising failure information of each of the second patterns.

11. A failure pattern prediction method comprising:
obtaining, by an optical parameter obtaining module, first optical parameters of first patterns and second optical parameters of second patterns;
extracting, by a dimensional reduction module, first data by performing a first dimensional reduction method on the first optical parameters;
generating, by a model generation module, a failure pattern prediction model by performing supervised learning based on first exposure data of the first patterns and the first data;
extracting, by the dimensional reduction module, second data by performing a second dimensional reduction method on the second optical parameters; and
verifying, by a model verification module, the failure pattern prediction model by comparing prediction data with second exposure data of the second patterns,
wherein the prediction data is obtained by applying the failure pattern prediction model to the second data.

12. The failure pattern prediction method of claim 11, wherein the first exposure data comprises wafer data extracted by exposing each of the first patterns, and
wherein the second exposure data comprises wafer data extracted by exposing each of the second patterns.

13. The failure pattern prediction method of claim 11, wherein the first optical parameters comprise at least one of Normalized Image Log-Slope (NILS), Image Log-Slope (ILS), maximum Intensity (Imax), minimum Intensity (Imin), optic critical dimension (CD), simulated CD, mask CD, an optical threshold, a normalized aerial image slope, and a ratio of optic and resist intensity, and
wherein the second optical parameters comprise at least one of NILS, ILS, Imax, Imin, optic CD, simulated CD, mask CD, an optical threshold, a normalized aerial image slope, and a ratio of optic and resist intensity.

14. The failure pattern prediction method of claim 11, wherein the first dimensional reduction method comprises at least one of principal component analysis (PCA), kernel PCA (KPCA), linear discriminant analysis (LDA), multidimensional scaling (MDS), singular value decomposition (SVD), locally linear embedding (LLE), isometric mapping (ISOMAP), Laplacian Eigenmaps (LE), independent component analysis (ICA), and t-distributed stochastic neighbor embedding (t-SNE).

15. The failure pattern prediction method of claim 11, wherein the supervised learning comprises at least one of Support Vector Machine (SVM), K-Nearest Neighbors (KNN), random forest, gradient boosting, naïve Bayes, and logistic regression.

16. A failure pattern prediction method comprising:
obtaining first optical parameters of first patterns;
extracting three-dimensional first data by performing a first dimensional reduction method on the first optical parameters;
generating a failure pattern prediction model by performing supervised learning based on the three-dimensional first data and first exposure data comprising failure information of each of the first patterns; and
verifying the failure pattern prediction model based on second patterns,
wherein the generating of the failure pattern prediction model comprises determining a hyper plane for classifying the first patterns in a virtual three-dimensional space based on whether the first patterns are a failure.

17. The failure pattern prediction method of claim 16, wherein the first dimensional reduction method comprises a principal component analysis (PCA), and wherein the supervised learning comprises a support vector machine (SVM) technique.

18. The failure pattern prediction method of claim 16, wherein the first data is extracted to include 90% or more of information about the first optical parameters.

19. The failure pattern prediction method of claim 16, wherein the verifying of the failure pattern prediction model comprises:
obtaining second optical parameters of the second patterns;
extracting three-dimensional second data by performing a second dimensional reduction method on the second optical parameters; and
extracting prediction data indicating whether each of the second patterns has failed by inputting the second data into the failure pattern prediction model.

20. The failure pattern prediction method of claim 19, wherein the verifying of the failure pattern prediction model is performed by comparing the prediction data with second exposure data comprising failure information for each of the second patterns.
